(19) United States
(12) Patent Application Publication
(10) Pub. No.: US 2009/0150797 A1
(43) Pub. Date: Jun. 11, 2009

(54) RICH MEDIA MANAGEMENT PLATFORM

(75) Inventors: Christian K. Burkholder, Los Angeles, CA (US); Darren M. Kramer, Los Angeles, CA (US)

Correspondence Address: FISH & RICHARDSON P.C., P.O. BOX 1022, MINNEAPOLIS, MN, 55440-1022, US

(73) Assignee: SUBCULTURE INTERACTIVE, INC., Los Angeles, CA (US)

(21) Appl. No.: 11/950,885

(22) Filed: Dec. 5, 2007

(51) Int. Cl. G06F 3/048

(52) U.S. Cl. 715/747

(57) ABSTRACT

A tool for and user-friendly method of managing rich media and other data from any device connected to a network. Managing rich media can include producing, editing, distributing, syndicating, tracking and viewing rich media content, contacts and other data and can be accomplished without expertise in computer programming. The rich media content can be distributed and/or syndicated to multiple destinations across the network and simultaneously edited across every destination. Additionally, the tool can track usage of the distributed rich media content.

### TECHNICAL FIELD

This disclosure relates to a rich media management tool and, more particularly, to a comprehensive platform, toolkit and database management system that facilitates the management of rich media in a user-friendly manner.

### BACKGROUND

The process of developing and distributing rich media can involve significant design prototyping in multiple application paradigms as well as significant technology software programming. In the rich media market, each project (e.g., each website, mobile campaign, email campaign, blog, social network page, etc.) may require a group of creative producers and artists working with programmers to develop custom solutions. This process can be very expensive, is rarely repeatable, time consuming and inefficient.

### SUMMARY OF THE INVENTION

The present disclosure describes a computer-based tool that a user can use to easily create an environment that includes a variety of rich media assets (e.g., songs, videos, images, text) from one location. So, for example, a user might use the tool to access and embed videos from the YouTube™ website, search a library of MP3 music and create on-the-fly playlists, search Flickr™ for images to create a slideshow or gallery, and send photographs taken with the user's camera phone directly to the database. The user may place all of those rich media assets (i.e., the videos, songs and photographs) into an environment that can be published, for example, to a website, an e-mail distribution list or a variety of other platforms/destinations. Those steps (and others) can be performed without having any knowledge of computer programming or professional design software.

The tool typically enables users to manage rich media and other data from any rich-media-compatible device connected to the network. The tool provides a largely intuitive, user-friendly interface and method for producing, managing, editing, distributing, syndicating, tracking and/or viewing/experiencing rich media content, contacts and other data. The tool is easy to use even without having significant expertise or knowledge of computer programming or design software. In some implementations, the tool can be used to publish rich media content to multiple platforms/destinations across a network. In those instances, the published rich media content can be simultaneously edited across every destination where the content appears. Certain implementations of the tool enable user to track usage of the published rich media data as well.

In some implementations, one or more of the following advantages may be present.

For example, the tool may allow individuals and marketing personnel with little to no knowledge of design, user experience planning, engineering and/or software programming to quickly and easily produce engaging rich content experiences and distribute that content across multiple platforms (destinations). Such platforms may include, for example, flash websites, rich media emails, interactive content, character lip-synch animations, slideshows, image and/or photograph galleries, music and sound collections, video collections, events sites and contact lists.

Additionally, some embodiments enable users to save significant amounts of time and money in the planning and execution of rich media content creation, distribution and online marketing campaigns. In some implementations, the techniques disclosed herein may eliminate (or at least reduce) the risk of viruses, hacking and other nefarious activities from rich media. The techniques disclosed herein also can provide a digital rights management system for rich media. In essence, some implementations provide an end-to-end solution for rich media management from conception to distribution to usage tracking.

According to certain embodiments, a highly granular tracking system is provided for tracking rich media usage across multiple platforms. This technique can greatly improve the communication process from business-to-business, business-to-consumer and consumer-to-consumer groups.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a schematic diagram of a computer system.

FIGS. 2A-2H are screenshots that show one implementation of the functionality provided by the system of FIG. 1.

FIG. 3 is a schematic showing one implementation of a computer-based rich media management tool 300.

FIGS. 4A-4E are screenshots that illustrate one implementation of a media librarian.

Like reference numerals refer to like elements.

### DETAILED DESCRIPTION

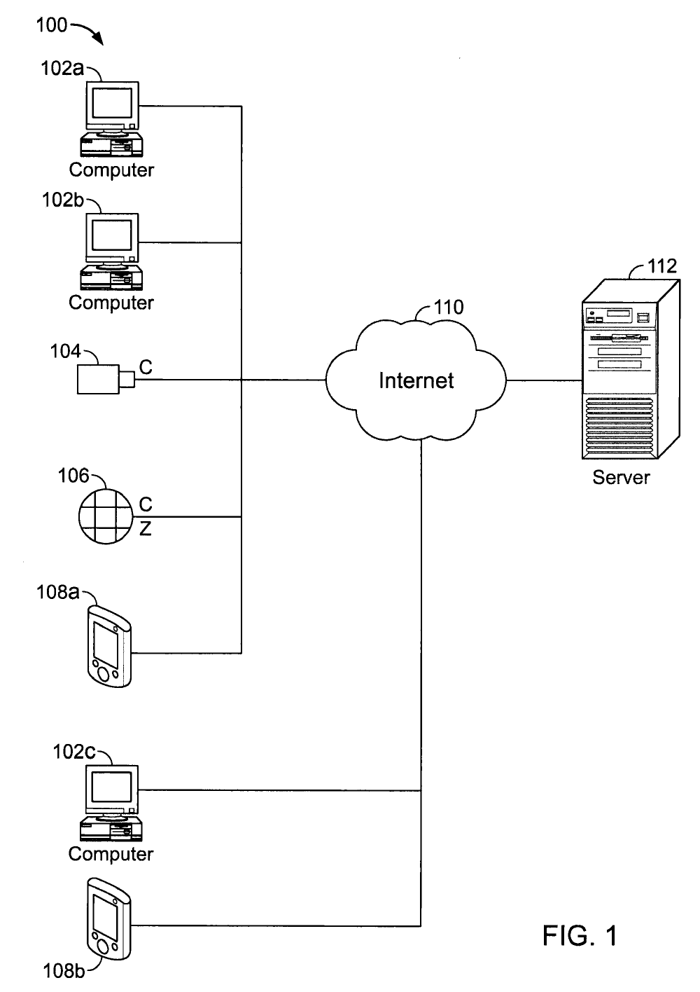

FIG. 1 is a schematic diagram of a computer system 100. The illustrated system 100 includes computers 102a, 102b, 102c, a video camera 104, an audio device 106 and hand held wireless communication devices 108a, 108b coupled to a network 110 (e.g., the Internet). In the illustrated implementation, each of those devices is rich-media-compatible (i.e., each device enables users to interact with rich media content). A server 112 also is connected to the network 110.

The illustrated system 100 has functionality that enables users to access a rich media management tool from any device connected to the network 110. The rich media management tool enables the users to produce, edit, distribute, syndicate, track and/or experience (e.g., view, interact with or listen to) rich media content, contacts and other data. Moreover, the tool typically provides all of those features to users in a user-friendly manner so that no knowledge of computer programming is required.

In some implementations, the tool can be used to publish the rich media content environment to selected platforms (i.e., destinations) across the network 110. Those destinations can include, for example, websites, mobile devices, blogs, social networks, group email distributions, instant messengers and message boards. If the rich media content environment has been published, in some implementations, the user can access the tool to simultaneously edit the environment across all platforms. In some implementations, this feature simplifies the process of managing the distribution of large amounts of information.

In some implementations, the tool provides a substantially closed environment. Such an environment may be substantially virus-proof and hacker-proof. In some implementations, the tool can support multiple user accounts and multiple users can login to each account. In some implementations, the tool includes a permissions system that accommodates the identification, classification and sharing of various types of rich media content across multiple users and multiple clients of those users.

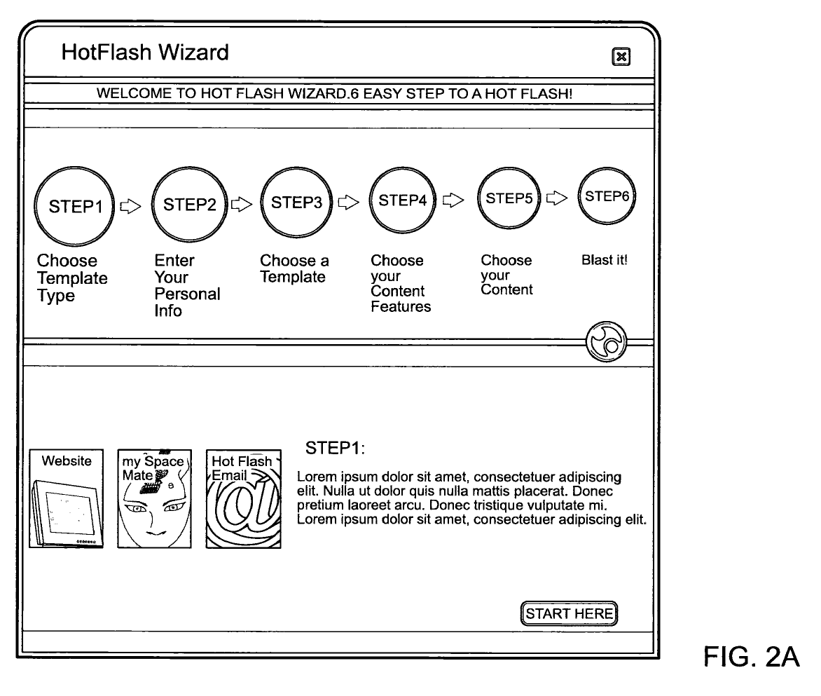

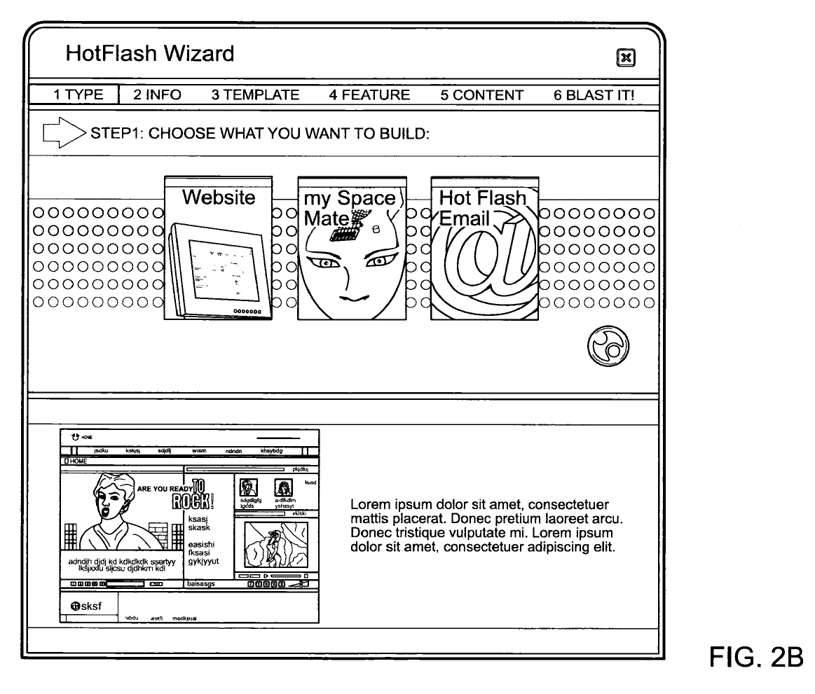

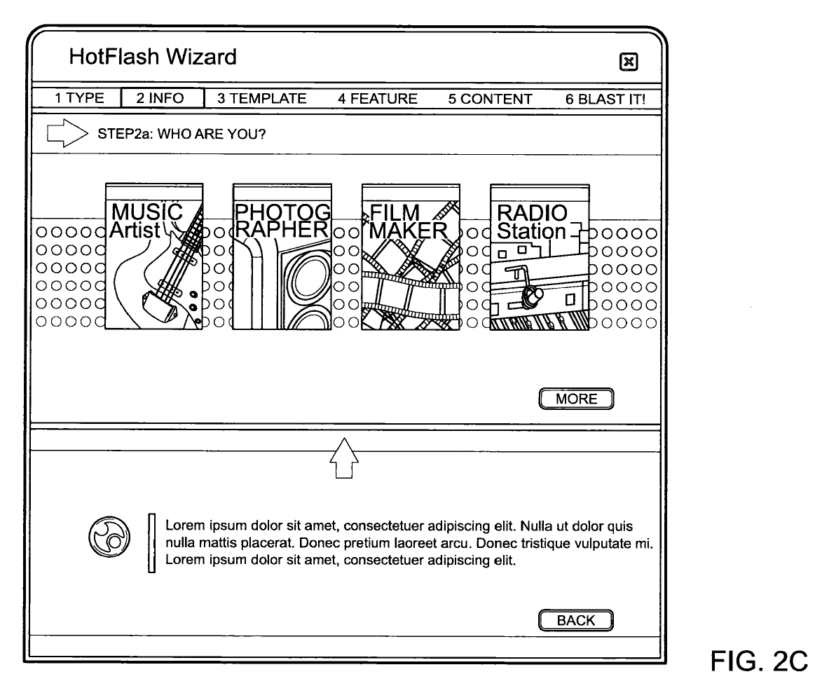

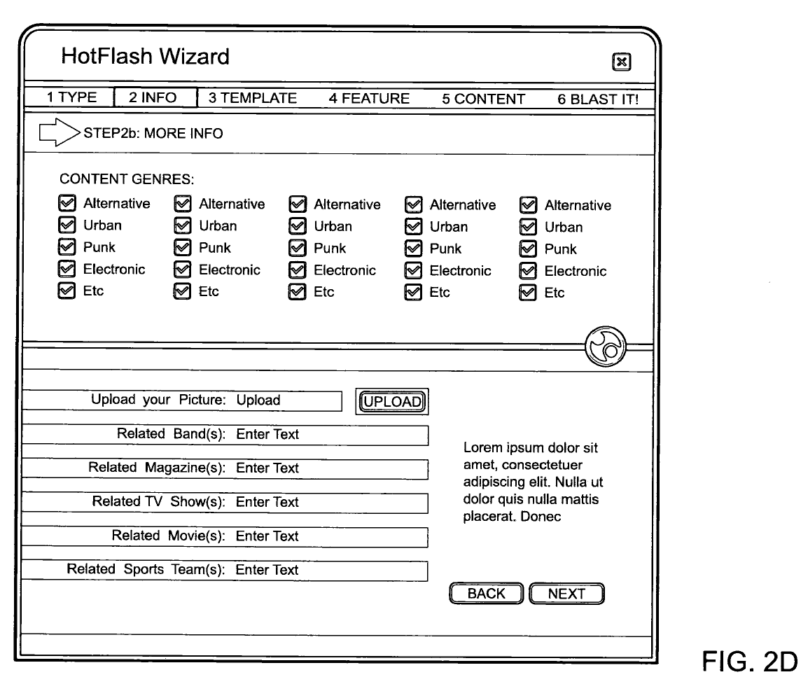

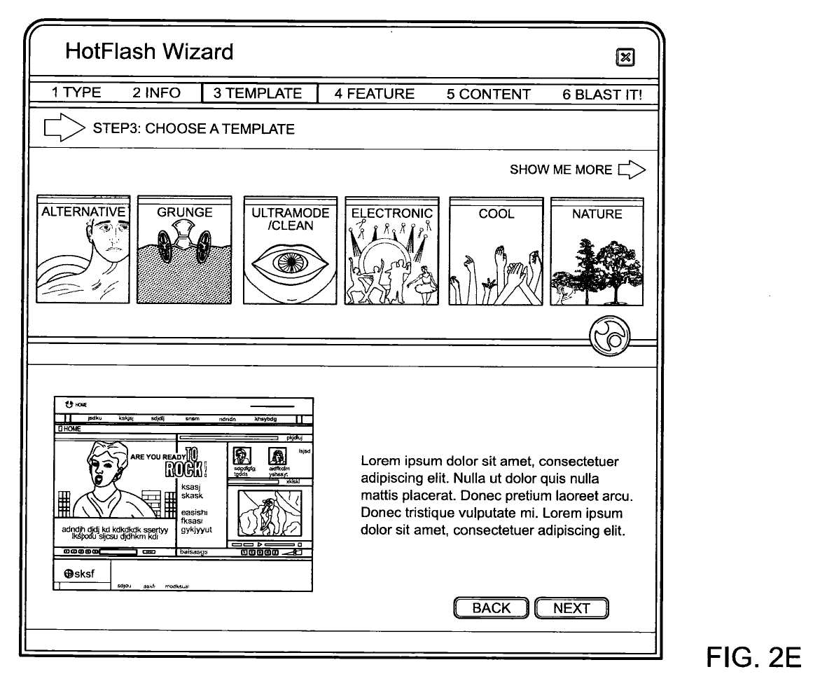

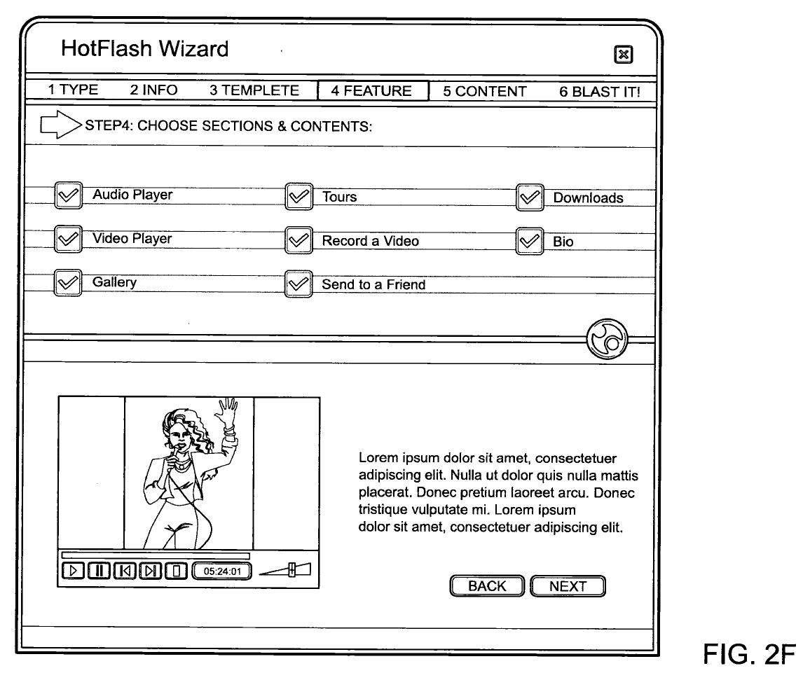

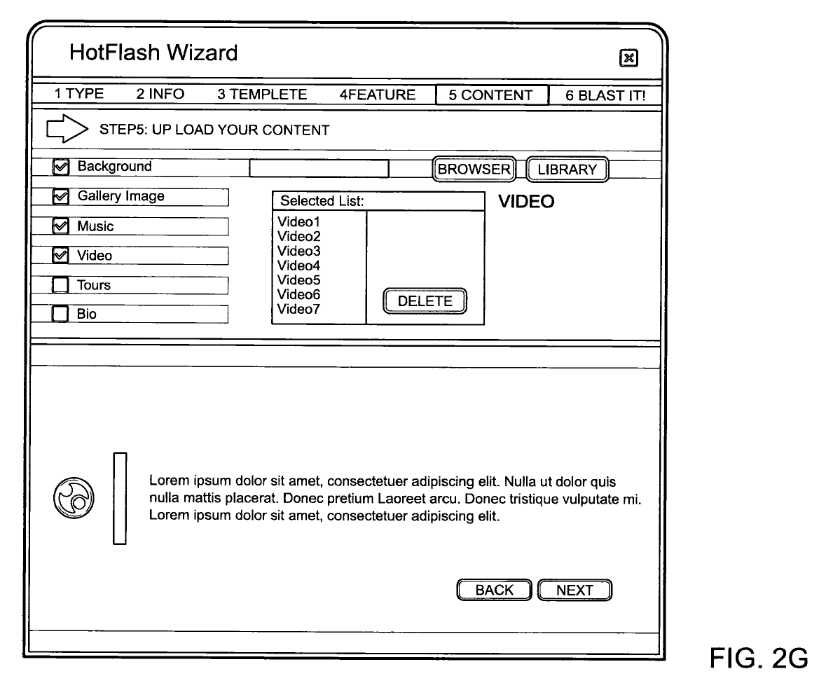

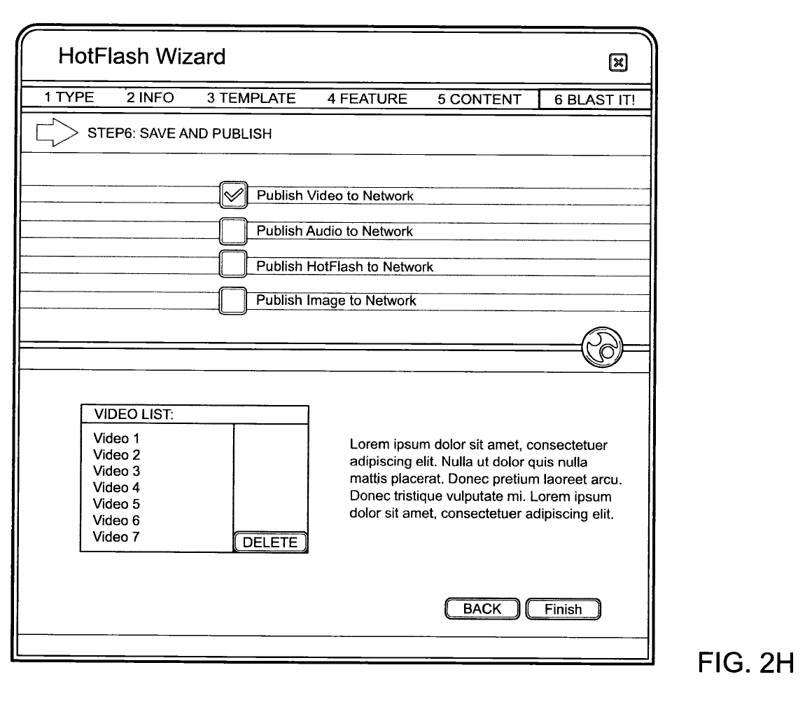

FIGS. 2A-2H are screenshots that show one example of the functionality provided by the system 100 in FIG. 1.

The particular example in FIGS. 2A-2H embody a software wizard that leads users through a series of steps to create and publish a rich media content environment. As is evident from the screenshots, the steps include presenting the user with easily-understandable choices (i.e. selectable options) to make regarding the environment including embedding rich media content into the environment. The illustrated screenshots may be viewable, for example, by accessing a website from computer 102a in FIG. 1.

FIG. 2A is an introductory screen that provides an overview of the steps involved in creating the rich media content environment.

The illustrated steps include: “choose template type”, “enter your personal info”, “choose a template”, “choose your content features”, “choose your content” and “blast it.” Each step includes an icon (labeled “Step 1” . . . “Step 6”) that a user can select to access the corresponding step. In some implementations, a description of each step may be provided in the text box in the lower right section of the screen. A link labeled “Start Here” is provided at the bottom right corner of the illustrated screen.

In some implementations, selecting the “Start Here” link calls up the “Choose Template Type” screen, which is illustrated in FIG. 2B. That screen prompts a user to choose a template type that corresponds to what the user wants to build. In the illustrated implementation, the template options include building a website (by selecting the “website” link), building a mySpace™ page (by selecting the “mySpace mate” link) and/or a building an email environment (by selecting the “hotflash email” link) The lower right section of the screen includes a text box that can provide written descriptions of the various templates. The lower left section of the screen provides a visual example of an exemplary template.

In the illustrated screen, and in other screens, a written description and a visual example appears at the bottom of the screen related to whichever link the user has positioned the cursor over.

A group of links is provided near the top of the screen. Those links are entitled “1 Type”, “2 Info”, “3 Template”, “4 Feature”, “5 Content” and “6 Blast It!.”Each of those links corresponds to one of the steps involved in the process. Those links are included in a number of other screens that are presented to the user. By selecting one of those links, a user can navigate from step to step, either in order or out of order.

In some implementations, selecting the link “2 Info” calls up the screen illustrated in FIG. 2C. That screen prompts the user to enter information about the user. More particularly, the illustrated screen includes icons, which a user can select to identify the user as either a “music artist”, a “photographer”, a “film maker” or a “radio station” person. A text box appears at the bottom portion of the screen and can include a description of the options presented to the user on this screen. The screen includes a “more” link, the selection of which presents the user with more options for categorizing who the user is.

The user selecting the “music artist” link, for example, calls up the screen shown in FIG. 2D. That screen prompts the user to identify genres for the desired rich media content. In the illustrated implementation, the genres presented include: alternative, urban, punk, electronic, etc., referring to musical genres. A user can select one or more of those options.

The screen in FIG. 2D also enables the user to upload a picture, identify related bands, related magazines, related television shows, related movies and related sports teams. The screen also includes a text box in its lower right corner that may include a description of the user's options presented on this screen.

In some implementations, selecting the “next” link near the bottom right corner of the screen calls up other screens that prompt the user to enter additional information about him or herself and to enter other general information related to the theme of the environment they are creating. Examples of other information include the user's name, address, birthday, gender, interests, key words, etc.

In some implementations, selecting the link “3 Template” calls up the screen of FIG. 2E. That screen prompts the user to identify a template (i.e., a style) for the rich media content environment the user is creating. In the illustrated implementation, the links for template choices include: alternative, grunge, ultramode/clean, electronic, cool and nature. A “show me more” link is provided, the selection of which causes the system to present to the user more template options. A description of the user's choices appears in the text box in the bottom right portion of the screen. An exemplary template appears to the left of the description.

In some implementations, selecting the link “4 Feature” calls up the screen of FIG. 2F. That screen prompts the user to choose sections for their rich media content environment. In the illustrated implementation, the choices presented to the user include: audio player, video player, gallery, tours, record a video, send to a friend, downloads and bio. A description of the user's choices is provided in the bottom right portion of that screen. An example of one of the choices (i.e., a video player) is shown at the bottom left portion of the screen.

If the user has selected “video player” in FIG. 2F and then selected the “next” link, the screen of FIG. 2G is called up. That screen prompts the user to upload rich media assets that correspond to the selections made in FIG. 2F. The illustrated screen presents the user with a list of videos, from which the user can make selections. The screen also includes a “browser” link, the selection of which calls up a browsing function that the user can use to browse through files for desired videos. The screen also includes a “library” link, the selection of which enables the user to access videos that are stored locally or externally at one or more locations (e.g., on YouTube™).

In some implementations, the choices presented to a user in the screen of FIG. 2G will depend on the sections (e.g., video players, audio players, etc.) the user has selected for inclusion in his or her rich media environment. So, for example, if the user selected (in FIG. 2F) to include a video player in his or her rich media environment, then the user would be prompted to upload videos in the screen of FIG. 2G.

As shown, the user can access rich media assets from a number of sources through accessing the tool.

By selecting “back” or “next” in the bottom right corner of the screen, a user can navigate between the various categories of content. So, for example, from the illustrated screen (which relates to uploading videos), if the user selects the “back,” a screen might be presented that prompts the user to upload music. Similarly, from the illustrated screen, if the user selects the “next” link, a screen might be presented that prompts the user to enter tour information (e.g., dates, times, locations, ticket information about a band's touring schedule).

In some implementations, selecting the link “6 Blast It!” calls up the screen of FIG. 2H. That screen enables the user to save and publish various aspects of the rich media environment the user created to a network (e.g., 110 in FIG. 1). Typically, once published, the environment containing rich media content will be accessible from any compatible device connected to the network.

The illustrated screen provides the user with several choices including: publish video to network, publish audio to network, publish hotflash (i.e., email) to network and publish image to network. Accordingly, a user may choose to selectively publish various aspects of the rich media content environment, separate and apart from the experience itself. The bottom portion of the screen provides a description of the functionality behind this screen. The bottom portion of the screen also shows the user the rich media content associated with each of the listed publishing events.

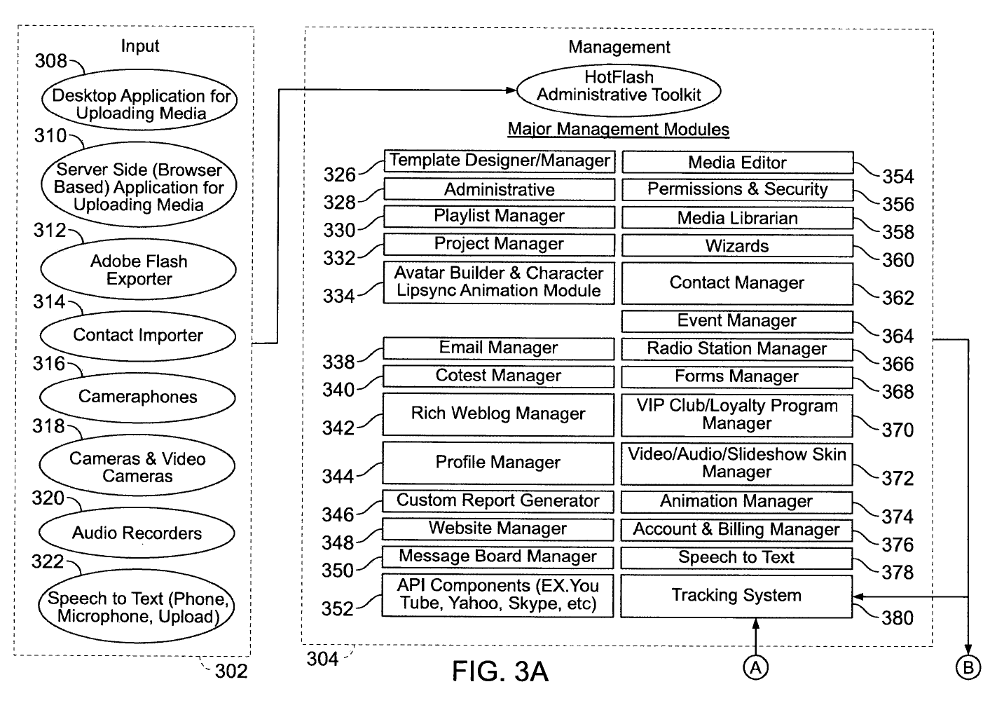

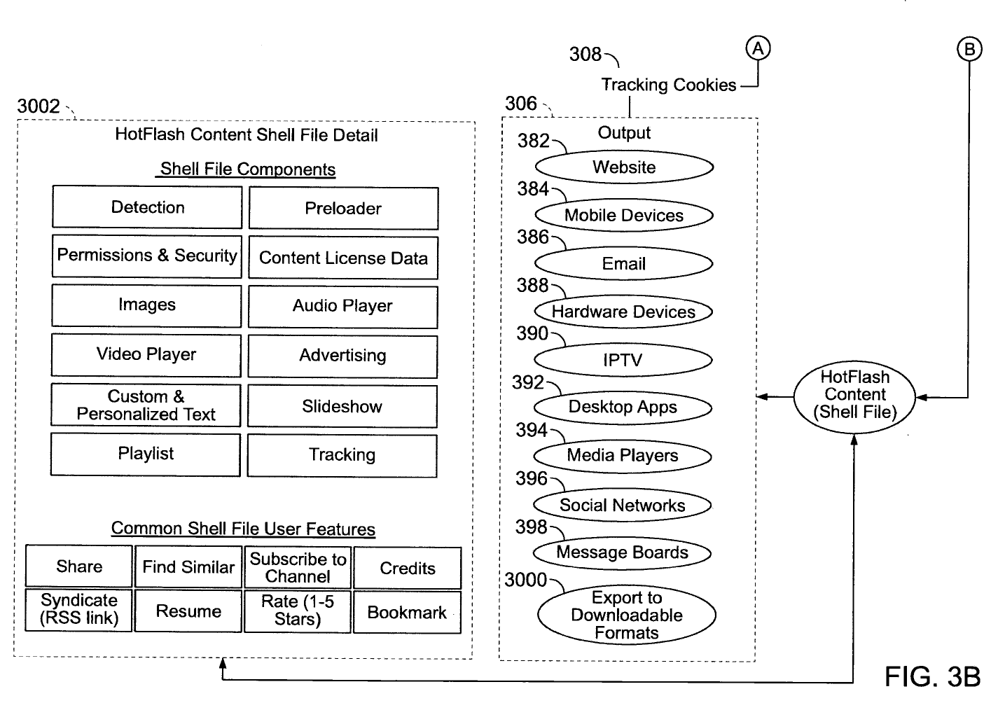

FIG. 3 is a schematic diagram of one implementation of a computer-based rich media management tool 300. The illustrated tool 300 includes functionality associated with the wizard of FIGS. 2A-2H as well as other functionality that relates to the management of rich media content.

The tool 300 can be accessed from any rich-media-compatible device connected to its network. In some implementations, the tool 300 enables users to produce, edit, distribute, syndicate, track and/or view an environment that includes rich media content, contacts and other data. Moreover, that functionality is typically provided in a manner that does not require the user to have any knowledge of computer programming. All of the functionality associated with the illustrated tool 300 is centralized so that it can be accessed, for example, by a user simply logging into the user's account. In certain embodiments, the tool 300 resides at least in part on the server 112 of FIG. 1.

The illustrated tool 300 includes groups of modules that relate to: input 302, management 304 and output 306 of rich media content and other data. The illustrated tool 300 also has functionality associated with tracking various information related, for example, to the usage of published rich media content.

The illustrated input group 302 includes a desktop application 308 for uploading media, a server side (browser based) application 310 for uploading media, a flash exporter 312, which is a plug in for the Adobe Flash environment, a contact importer 314, cameraphones 316, cameras and video cameras 318, audio recorders 320 and speech to text tools 322.

The desktop application 308 and the server side application 310 enable a user to upload files and metadata to the management section of the tool 300. Those applications typically support audio, video and images. In some implementations, the applications 308, 310 can transcode video to a flash video (FLV) format that supports multiple video codecs. Additionally, in some implementations, the applications 308, 310 can provide client-side format conversion for audio and image files. The applications 308, 310 also may be able to review and edit metadata associated with the files that are uploaded.

The flash exporter 312 is a multi-platform software plug-in (i.e., extension) that can provide users with the means to export media assets (e.g., flash symbols) that are created, for example, in Adobe's Flash development application. Such content typically can be manipulated by the tool 300 and distributed to multiple output platforms.

In one implementation of a flash exporter 312 workflow process, a flash plugin for Adobe's flash development software application is installed on a local machine. The user prepares content in the flash application and saves that content on a timeline as a “movie clip” asset. The user the selects an icon (e.g., “hotflash exporter”) at the local machine. The flash exporter converts each frame of the timeline to an individual slide and converts content to XML, images, video and audio assets. Then, a Java-based custom application parses each piece of content. The user attached keywords, descriptions and properties to each asset in the Java-based application. The Java-based application logs into the user's HotFlash account at tool 300 remotely through a web service. The content is uploaded into the user's account. Subsequently, the user can log into the user's account and load a new project with the content that is uploaded, x-y stage placement and layer depths and slides intact. More particularly, the Java-based application will export the symbols, graphics and slides into the Platform while preserving their properties such as scale, rotation, relative location on the page, symbol type, color transform data, etc.

The contact importer 314 enables users to import contact data in a variety of formats. Such contact data may include customizable field structures.

The cameraphones 316, cameras and video cameras 318, audio recorders 320 and speech to text tools 322 may enable a user to capture audio and/or video images for use in a rich media environment. In some implementations, those devices utilize broadband carrier standards, such as evolution-data optimized (EVDO), which is a telecommunications standard for wireless transmission of data through radio signals, typically for broadband Internet access. Those devices also may include a software operating system that is adapted to automatically log a user into the user's account, send and receive data from the user's remote location and control the process of sending and receiving content across the network.

There are multiple ways in which images (e.g., photographs and videos) taken with a camera phone can be captured for use with the tool 300. In one example, a user takes photographs with a camera phone. That user then sends the photographs to a predetermined address that corresponds to a system server (e.g., server 112 in FIG. 1). The photographs can be sent using, for example, short message service (SMS) or multi-media messaging service (MMS). The server 112 receives and de-serializes the photographs. The server 112 converts the photographs to a standard format (e.g., jpg or flv). The server 112 queries the user's phone number in a database. The server posts the photographs to a library and assigns them to the user's account.

In another example, a user takes photographs with a camera phone that has a mobile software application loaded thereon that enabled to the user's camera phone to interact directly with the system server (e.g., server 112 of FIG. 1). The user drags the photographs into the mobile application on the camera phone and, from the camera phone, directs those photographs to be sent to the server 112. The server 112 receives and de-serializes the photographs. The server 112 converts the photographs to a standard format (e.g., jpg or flv). The server 112 queries the user's phone number in a database. The server posts the photographs to a library and assigns them to the user's account.

Regardless of how the images are captured and sent to the server 112, once they are posted to the library and assigned to the user's account, the user can log into the user's account and find photos and/or videos. The user is then able to post, share, edit, display and/or distribute those photos or videos as the user desires.

The management group of modules 304 includes an administrative toolkit 324 that includes: a template designer/manager 326, an administrative module 328, a playlist manager 330, a project manager 332, an avatar builder and character lip synch animation module 334, a substation manager and wizard 336, an email manager 338, a contest manager 340, a rich weblog manager 342, a profile manager 344, a custom report manager 346, a website manager 348, a message board manager 350, application programming interface (API) components (e.g., to interface with YouTube™, Yahoo™ and/or Skype™) 352, a media editor 354, a permissions and security module 356, a media librarian 358, wizards 360, a contact manager 362, an event manager 364, a radio station manager 366, a forms manager 368, a VIP club/loyalty program manager 370, video/audio/slideshow skin manager 372, an animation manager 374, an account and billing manager 376, a speech to text module 378 and a tracking system 380.

The template designer/manager 326 enables users to create, manage, edit and save drag-and-drop rich media compositions. More particularly, users can place graphics, audio players, video players, animation, text, forms, contest information and embedded personalization directly on any slide. Users also can add, edit and delete multiple slides; set transitions, timers and links inside and outside of the composition. Distribution of saved templates is generally controlled through the project manager 332.

In a particular implementation, the user would open a new template from a list of available templates. The user then adjusts template properties (e.g., template name, arrangement of graphical content and components, playlists of content or albums of photos, etc.). Next, the user adjusts slide properties that correspond to the template. Such properties may include, for example, slide name, background color, background image and transition features. The user then adjusts component properties. For example, if the component is an image gallery, the component's properties may include: the name of the gallery, the size of the gallery, the arrangement of images in the gallery, whether images from the gallery should be presented stretched, as a slideshow, in random order, with or without transitions, etc. The properties may also include the presence or absence of user-accessible controls in the template. The user may be able to create new slides and to create navigational features such as menus or buttons to move between slides. The administrative module 328 addresses administrative tasks associated with the tool 300.

The playlist manager 330 enables users to easily edit, save and distribute playlists that include video, audio and/or images. Image playlisting results in image galleries. Playlists can be embedded in and/or syndicated in multiple content templates, compositions or projects. In some implementations, if a playlist is updated, the corresponding playlists at all the locations in which that playlist was embedded or syndicated, also will be updated automatically. In one implementation, a user can use the playlist manager 330 to start, for example, a new video playlist. The user drops a new video component into the content template. The user then searches or browses the media librarian for content. The user can drag selected content into a playlist, which can be saved and embedded where desired. Syndicated playlists of graphical, video or audio (musical) content can be made available through the tool to grant permissions to other users of the platform to embed those playlists in their own, unique projects. When the original playlist creator updates those playlists, anywhere the playlist has been syndicated it will reflect those changes and/or updates. For instance, a radio station might make a playlist of music available for syndication. Very many radio station listeners syndicate the music playlist and embed it on a variety of projects being powered by the Platform including social network pages, websites, blogs and through email. When the station updates the playlist of songs, anywhere that playlist has been embedded is updated with the new list instantaneously. Likewise, the station would receive a tracking report through the platform which reveals where the songs have been played and any related geographical or demographical information as well as purchased download information related to the usage of the playlist.

The project manager 332 enables users to send saved content templates to email, embed saved templates in a website, send saved templates to a mobile device or send saved templates to any other point of distribution in a computer system (e.g., computer system 100 of FIG. 1).

In some implementations, the project manager 332 includes a project publisher that enables the publishing of various content. In some implementations, the project publisher provides a publishing wizard that allows a user to define a project to be published. A user can use a template the user has created to publish a single entity such as a website. Alternatively, the user can use a template the user has created to publish multiple entities such as, mySpace widgets, a website and an instant messenger widget. A widget may be considered an interface element that a computer user interacts with, such as a window or a text box.

In some implementations, the user can schedule emails and/or expire emails ahead of time. Additionally, in some implementations, the project manager 332 enables a user to view existing data and usage statistics regarding a selected project. Additionally, the project manager 332 typically provides users access to embeddable code that can be copied and pasted to embed various content to various locations.

The avatar builder and character lip synch animation module 334 enables users to pair an audio file to an avatar in such a manner that the avatar appears to be speaking. In some implementations, the audio file may be uploaded by the user. In some implementations, the user can create the audio file by calling a phone number and recording a message over the phone. In some implementations, the user can create the audio file by speaking into a microphone. Once audio has been captured, the user can build his or her own avatar or access a library of existing avatars, stored either locally or remotely. A lip-synch library may be provided that can analyze waveforms associated with the audio file. From that analyses, the lip-synch library assigns phonemes to segments of the waveform. This outputs a file which triggers different mouth states on the avatar automatically to synchronize the avatar with the audio file during playback.

The email manager 338 enables users to send personalized individual and batch emails to lists of queried contacts. Personalization includes ability to merge any data into each email. Personalization may be embedded and preserved in flash, text and HTML versions of email.

The contest manager 340 enables users to add drawings competitions and others forms of contest at the click of a button. Adding a contest automatically creates all the necessary forms and database tables related to the contest.

The rich media weblog manager 342 enables users to create, manage and update rich media weblogs. Since the weblogs are in a rich media environment, the look and feel and presentation can be changed on the fly for one, more or all entries in a weblog.

The profile manager 344 enables users to manage users' profiles in the tool. In some implementations, the profile manager 344 enables users to manage other profiles, such as Plaxo, mySpace, YouTube, Facebook, etc.

The custom report manager 346 enables users to create customized rich media usage and response reports.

The website manager 348 manages certain aspects of the tool's 300 interactions with the creation and management of “websites” on a user specified domain.

The message board manager 350 allows for management of one or more rich media message boards which can be displayed at one or more destinations.

The application programming interface (API) components 352 define a source code interface to support requests for services to be made of the tool 300 by a computer program (e.g., YouTube™, Yahoo™ and/or Skype™).

The media editor 354 enables users to edit video, audio, and images through a web browser wherein server side scripts perform the editing functions. In some implementations, a flash plugin for Adobe's flash development software application is installed on a local machine. The user prepares content in the flash application and defines groups/assets into flash symbols. The user then chooses “hotflash exporter” option, that activates an exporting function at the local machine. The exporting function converts each defined symbol of each frame of the timeline to a slide and converts content to XML, images, video and audio assets. A Java-based custom application parses each piece of content. The user then attaches keywords, descriptions and values to each asset in the Java application. The Java application then logs into the user's account at tool 300 remotely through a web service. Content is then uploaded into the user's account.

Once content has been uploaded into the user's account, the user can log into the user's account and can load the new project with content, x-y stage placement and slides intact. More generally, the Java-based application will export the symbols, graphics and slides into the Platform while preserving their properties such as scale, rotation, relative location on the page, symbol type, color transform data, etc.

The permissions and security module 356 controls a user's access to accounts and various groups. In one implementation, the permissions and security module 356 enables a client administrator to add a new user. To do that, the client administrator might access the tool 300 and select an “add new user” link from a client administration menu. The tool 300 then prompts the administrator to enter user information including, for example, the user's name, address, account information notes, date of birth, phone number, etc. Once such information is entered, the tool 300 enables the administrator to create the account for the new user.

In some implementations, the permissions and security module 356 also enables a client administrator to edit a user's account. In some implementations, the permissions and security module 356 enables an administrator to assign permissions to a user. That assigning of permissions may be accomplished by dragging the user's information into one or more groups. In that instance, each group might have permission to access certain types of files, but not other types of files.

The media librarian 358 enables users to conduct simple searches for rich media content. Users can browse, search, add, delete, modify and manage use-specific, group-specific and global content including images, audio, video, templates, slide shows, playlists, player skins and any other content type that the system supports. In some implementations, the media librarian supports external repositories of content using application programming interfaces (APIs). These may include, among others, YouTube, Brightcove, Mappr, Odeo, Ebay, Yahoo Images, Photobucket, Flickr and Itunes.

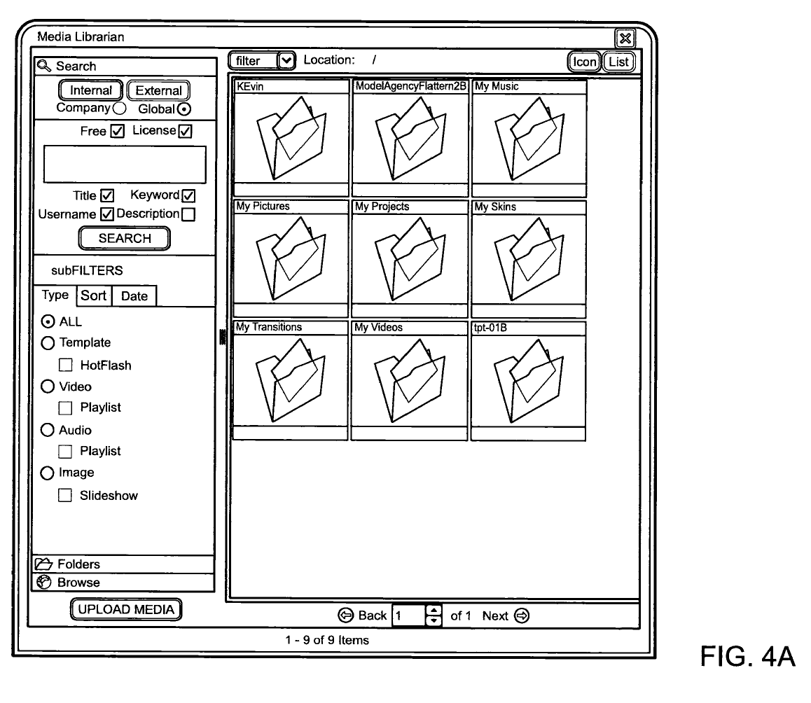

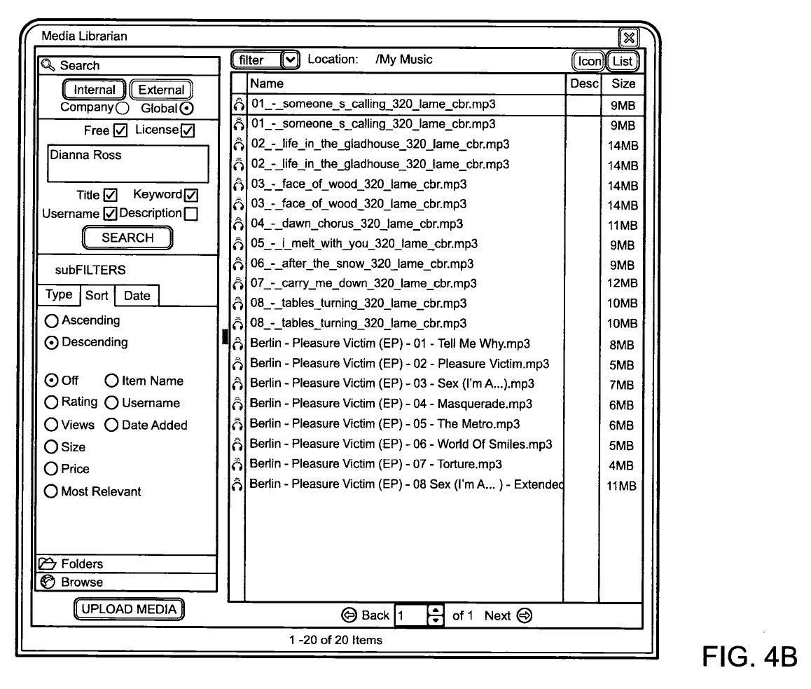

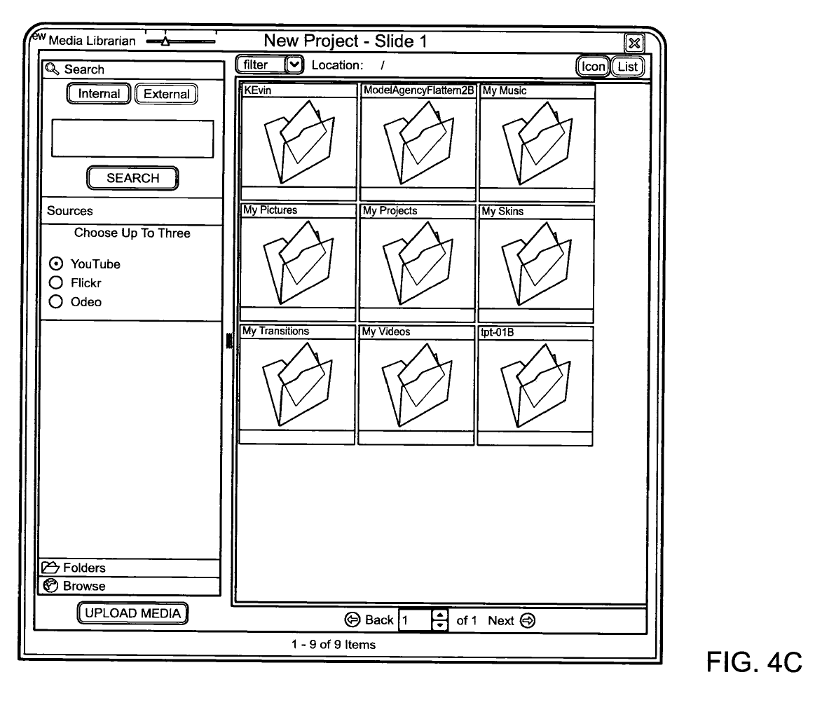

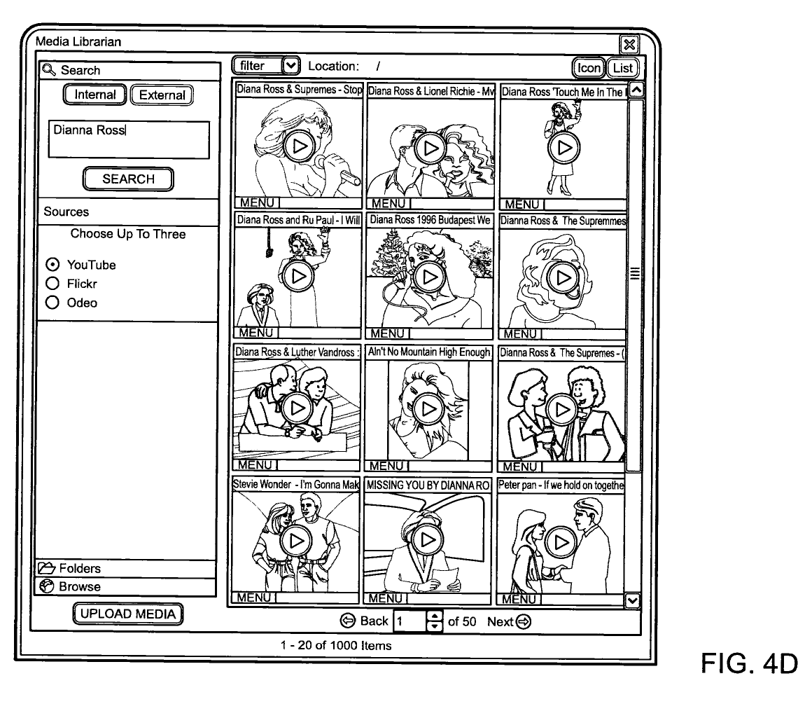

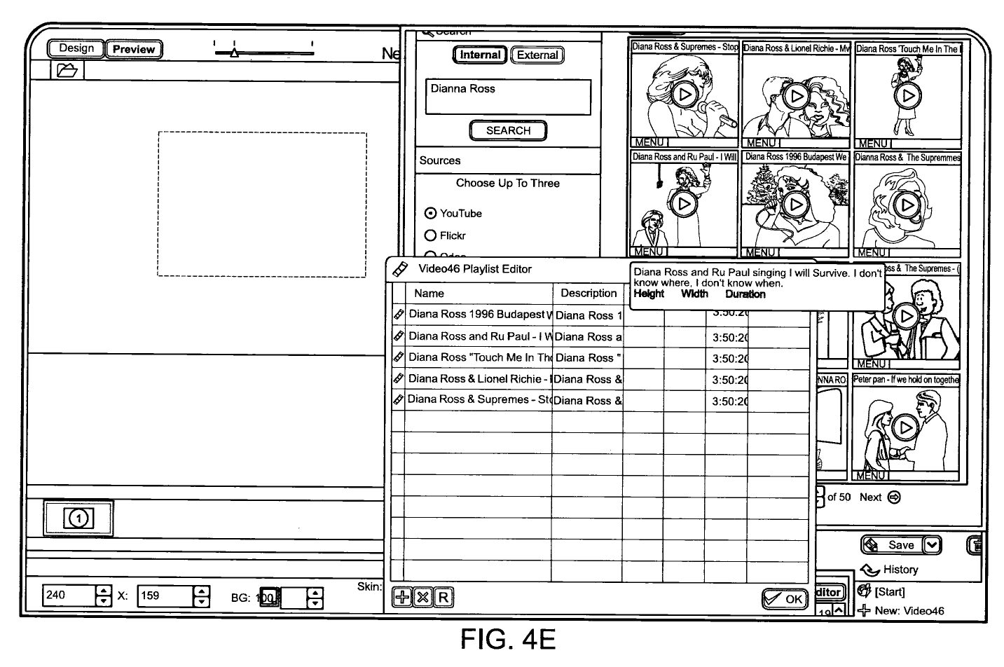

FIGS. 4A-4E are screenshots that illustrate some functionality of one implementation of a media librarian 358.

The screenshot of FIG. 4A includes links that enable a user to search either internal files or external files. Additionally, the user can choose to search either company-wide or globally. Moreover, a user can search for either free or license content.

A text box enables the user to enter search strings. Also, the user can specify whether titles, keywords, usernames and/or descriptions should be searched for the search string.

The illustrated screenshot also enables users to select sub-filters. Examples of sub-filter options are labeled “all”, “template”, “video”, “audio” and “image.” Sub-filters are dynamic and can expand and contract; determined by new types of content and components which can be added as the system evolves. By selecting, for example, “video”, a user would search only for videos, excluding templates, audio and images. The screenshot also indicates sub-categories beneath some of the sub-filter options. For example, the sub-category “hotflash” is beneath the “template” sub-filter, the sub-category “playlist” is beneath the “video” sub-filter, the sub-category “playlist” is beneath the “audio” sub-filter and the sub-category “slideshow” is beneath the sub-filter “image”. The right side of the screen presents to the user a results field that includes a collection of folders that include relevant content.

In the illustrated implementation, the user has conducted an internal search for global content that is free or available by license. The text box includes no search terms. The results field shows nine folders that include relevant content.

In some implementations, selecting the folder entitled “My Music” in FIG. 4A, calls up the screen of FIG. 4B. The screen of FIG. 4B includes a list on the right side of the screen of rich media content in the folder entitled “My Music.” The illustrated list includes a number of mp3 files. The lower left portion of the screen enables the user to sort the information in the list in a number of ways. As shown, the list is sorted in alphanumeric descending order. A user can select files from the list to create a playlist.

FIG. 4C is similar to FIG. 4A except that FIG. 4C shows a screen being used to conduct an external search. The external sources of rich media that can be searched include YouTube, Flickr and Odeo. Other sources and different sources may be available as well.

In FIG. 4D, a user has entered the search term “Diana Ross” into the text box, selected the “YouTube” link and hit “search.” The right side of the screen show the results of a search conducted at YouTube for any rich media that relates to Diana Ross. The results include a number of videos.

FIG. 4E shows that a user can create a playlist (through playlist editor) based on the results of the search. In some implementations, the user does this by simply clicking and dragging the videos from the results box in the media librarian into the playlist editor section of the screen. The playlist can be saved, edited and/or embedded into one or more projects/environments.

In some implementations, the user can access and manipulate metadata related to files through the media librarian.

Referring again to FIG. 3, the wizards 360 include user interface elements that lead the user through a sequence of dialogs. In graphical user interfaces, for example, a dialog box is a special window, used in user interfaces to display information to the user, or to get a response if needed. They are so-called because they form a dialog between the computer and the user-either informing the user of something, or requesting input from the user, or both. More particularly, the wizards 360 enable a user to manage the look and feel of a rich media environment, as well as manage contact lists.

The contact manager 362 enables users to import, edit, query, assign, invite and manage contacts. In some implementations, the contact manager 362 also enables users to manage contact lists elsewhere, such as at Plaxo, mySpace, YouTube, Facebook, etc. That functionality may be incorporated into external IP telephony APIs.

In some implementation, the user imports or manually create contact records. In some instances, that involves the user synchronizing their contact records with a local database management system (DBMS). Examples of DBMSs include Oracle, DB2, Microsoft Access, Microsoft SQL Server, PostgreSQL, MySQL, Filemaker and Sybase Adaptive Server Enterprise. The contact manager 362 can enable a user to edit contacts, query contact records, email contacts, assign contacts to other user and invite contacts to connect to and use the tool 300. For user emails, the contact manager 362 may be adapted to perform rich media field merges and track contact usage, response, etc. Additionally, if an email server responds with an error, the contact manager 362 may append the corresponding contact information with an error message. A user can access the tool 300 to query for errors and view and edit those errors.

In some implementations, the contact manager 362 can interact with various web services (e.g., mySpace, Youtube, Plaxo, Facebook, etc.). In those instances, the user imports or manually creates contact records. The user then logs into one or more of the user's web service accounts. In some instances, the user has installed a mobile contact manager on a mobile device. The user's contacts at the web services that are also contacts at the user's account at tool 300 update their contact records. In that sense, contact records are updated across the network automatically.

One way to import contacts to the user's account includes the user exporting a contact list to the user's local hard drive, for example, to a .csv file. The user then logs into the user's account at tool 300 and directs the tool to import contacts. The user then selects the contact group to import the .csv file into. The user then uses a local file browser to find the .csv file. After the file has been imported, the user is asked to match their data into the correct corresponding fields. The contacts are imported into the database and statistics are shown to the user that identify possible problems.

The event manager 364 enables users to post events in a rich media calendar program which can be distributed across the network 110. In some implementations, calendaring includes a rich media invitation/rsvp management system and customization of calendar and event displays. Photographs and videos taken at an event can be posted at a later date and logically coupled to the event.

In some implementations, the radio station manager 366 enables users to set to set up scheduled music, voice and advertising tracks for an online radio station. The radio station can be adapted to support multiple output formats including, for example, Flash, Winamp, Windows Media Player, etc. Usage of each radio station can be tracked and users who own each station may be may be automatically billed for royalties based on listener hours.

Additionally, in some implementations, the radio station manager contains synchronization features that synchronize rich media images and interactive content to audio being played. Accordingly, various information (e.g., advertisements for related products) related to the media being accessed could be presented to the user. For example, if a particular song by a particular band is being played, the album cover, the artists' biography and other information pertaining to the artist could be presented to the user. Additionally, links to download the song being listened to or other music from the band or similar artists could be presented to the user. Such data may be obtained from 3^{rd} party websites or locally. In addition, graphical advertising and promotions can be inserted on the timeline from the radio station.

The forms manager 368 enables a user to create custom data forms on the fly which can be easily embedded into one or more templates.

In some implementations, the VIP club/loyalty program manager 370 is an extensive points-based loyalty program management program. This manager 370 may enable business users, for example, to assign loyalty points to content and transactions (such as forwarding to friends, opting in, viewing, rating, voting on content, etc.). These points can be used for coupons, discounts and prizes by consumers that opt in through interacting with the tool 330.

The video/audio/slideshow skin manager 372 typically enables users to modify the look of video, audio and slideshow player skins.

The animation manager 374 enables users to automate time-line based animation.

The account and billing manager 376 manages users' accounts and processes billing for those accounts.

The speech to text module 378 converts recorded voice information to text and displays it within a template. Text content can be distributed across any platform supported by the tool 300. Uses include speech-to-text blogs (i.e., phlogging), speech-to-text greeting cards, websites, mass emails, mobile SMS. In some implementations, handicapped persons (and others) are able to manage all interaction with the tool 300 through voice commands.

The tool's 300 tracking system 380 allows for tracking of any nested or whole piece of data, content or information in multiple ways. It achieves this by sending usage information and variables back to the tracking database and log through custom web services. The tracking system tracks various types of content and data. Tracking information can be reviewed and queried by individual user and/or group or multiple groups.

In some implementations, the following data can be tracked: time of listening, viewing, watching of media including audio, video, animation, games and other; clicks inside of a rich media piece of content; forwards and sharing data; response forms; geographic data; demographic data; psychographic data; contact data; custom forms data; contest data; opens; purchased or free downloads of media files such as MP3s, videos or graphical images; ratings and voting data.

The possible output destinations included in the illustrated output section 306 of the tool 300 include a website 382, mobile devices 384, email 386, hardware devices 388, IPTV (i.e., Internet Protocol Television) 390, desktop applications 392, media players 394, social networks 396, message boards 398 and export to downloadable formats 3000. Typically, XML-based content is distributed to those platforms.

The illustrated tool 300 also includes hotflash content shell file components 3002. Those components are typically XML based. They relate to points of distribution and typically include all of the required components to display and control content.

In the illustrated implementation, the shell file components relate to detection, permissions & security, images, video players, custom & personalized text, playlists, preloaders, content license data, audio players, advertising, slideshows and tracking. The illustrated common shell file user features are share, find similar, subscribe to channel, credits, syndicate, resume, rate and bookmark.

A number of embodiments have been described. Nevertheless, it will be understood that various modifications may be made without departing from the spirit and scope of the invention.

For example, some implementations of the tool may be modified to include only some of the aspects disclosed herein. Additionally, the tool may be modified to add functionality thereto to enhance its utility.

Various features of the system may be implemented in hardware, software, or a combination of hardware and software. For example, some features of the system may be implemented in computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

Accordingly, other implementations are within the scope of the claims.

What is claimed is:

1. A computer-based method of managing rich media with a rich media management tool, the computer-based method comprising:
presenting a series of user-selectable options at a device coupled to a network, wherein the user-selectable options relate to creating an environment that includes rich media content;
receiving a user's selection of one or more of the options from the device; and
in response to the user's selections, creating an environment that includes rich media content corresponding to the user's selections.

2. The computer-based method of claim 1 further comprising:
enabling access the rich media management tool from a plurality of devices coupled to the network.

3. The computer-based method of claim 1 wherein the series of selectable options comprises object-oriented graphical symbols that the user can manipulate from the user terminal.

4. The computer-based method of claim 1 further comprising:
publishing the environment to one or more platforms across the network.

5. The computer-based method of claim 4 further comprising:
receiving instructions from the device to edit the published environment; and
in response to the received instructions, automatically editing the published environment at all of the platforms, to which the rich media content environment has been published.

6. The computer-based method of claim 4 further comprising:
monitoring usage of rich media assets in the published environment; and
collecting metrics regarding the monitored usage.

7. A computer-based method of managing rich media, the computer-based method comprising:
accessing a rich media management tool through a device coupled to a network;
reviewing a series of user-selectable options presented at the device, wherein the user-selectable options relate to embedding rich media content into an environment;
selecting one or more of the selectable options at the device;
wherein the tool, in response to the user's selections, creates the environment including rich media content that corresponds to the user's selections and publishes the environment to one or more platforms.

8. The computer-based method of claim 7 wherein the series of selectable options comprises object-oriented graphical symbols that the user can manipulate from the user device.

9. The computer-based method of claim 7 further comprising:
receiving instructions from the device to edit the published environment; and
in response to the received instructions, automatically editing the published environment at all of the platforms, to which the rich media content environment has been published.

10. The computer-based method of claim 7 further comprising:
monitoring usage of rich media assets in the published environment; and
collecting metrics regarding the monitored usage.

11. A computer system comprising:
a device coupled to a network;
a rich media management tool accessible from the device;
a source of rich media content on the network;
wherein the rich media management tool:
presents a series of user-selectable options at the device, wherein the user-selectable options relate to embedding rich media content from the source of rich media content into an environment;
receives the selections of the user-selectable options from the device;
in response to the received selections, creates an environment that includes rich media content that corresponds to the received selections and publishes the environment to one or more platforms.

12. The computer system of claim 11 wherein the series of selectable options comprises object-oriented graphical symbols that the user can manipulate from the device.

13. The computer system of claim 11 wherein the rich media management tool further:
receives instructions from the device to edit the published environment; and
in response to the received instructions, automatically edits the published environment at all of the platforms, to which the rich media content environment has been published.

14. The computer-based method of claim 11 wherein the rich media management tool further:
monitors usage of rich media assets in the published environment; and
collects metrics regarding the monitored usage.

15. A computer-based method of advertising, the computer-based method comprising:
publishing a rich media environment that includes a selection of rich media assets over a network;
tracking usage of the published rich media assets; and
when a rich media asset is being accessed, presenting an advertisement that corresponds to the rich media asset being accessed.

16. The computer-based method of claim 15 wherein the advertisement is for a product or service that relates to the rich media asset being accessed.

17. The computer-based method of claim 15 further comprising, prior to publishing the rich media environment:
accessing a rich media management tool from a device coupled to a network;
reviewing a series of user-selectable options at the device, wherein the user-selectable options relate to embedding rich media assets into the rich media environment;
selecting one or more of the user-selectable options at the user terminal;
wherein the rich media management tool, in response to the selections, creates an environment that includes rich media content that corresponds to the selections.

18. The computer-based method of claim 17 further comprising:
using the rich media management tool to publish the rich media environment.

19. A method of distributing rich media content, the method comprising:
publishing a rich media environment that includes a selection of rich media assets over a network;
monitoring usage of the published rich media assets; and
paying one or more owners of the published rich media assets based on the monitored usage of each published rich media asset.

20. The method of claim 19 further comprising, prior to publishing the rich media content:
accessing a rich media management tool from a device coupled to a network;
reviewing a series of user-selectable options at the device, wherein the user-selectable options relate to embedding rich media assets into the rich media environment;
selecting one or more of the user-selectable options at the user terminal;
wherein the rich media management tool, in response to the selections, creates an environment that includes rich media content that corresponds to the selections.

21. The computer-based method of claim 20 further comprising:
using the rich media management tool to publish the rich media environment.

22. A method comprising:
collecting rich media assets from a plurality of sources over a network;
establishing a rich media playlist from the collected rich media; and
controlling, with the rich media playlist, content at a plurality of destinations.

23. The method of claim 22 wherein the plurality of destinations include two or more of the following:
a website,
a social network page,
a blog, and
an email.

24. The method of claim 22 further comprising syndicating the playlist to destinations associated with multiple users and enabling the multiple users to embed the playlist into their respective network environments.
